(19) United States
(12) Patent Application Publication
(10) Pub. No.: US 2008/0105201 A1
(43) Pub. Date: May 8, 2008

(54) SUBSTRATE SUPPORT COMPONENTS HAVING QUARTZ CONTACT TIPS

(75) Inventors: TIMOTHY RONAN, San Jose, CA (US); Yuanhong Guo, San Jose, CA (US); Robert Decottignies, Redwood City, CA (US); Todd W. Martin, Mountain View, CA (US); Darryl K. Angelo, Sunnyvale, CA (US); Song-Moon Suh, San Jose, CA (US); Nitin Khurana, Milpitas, CA (US); Edward Ng, San Jose, CA (US)

Correspondence Address: JANAH & ASSOCIATES, P.C., 650 DELANCEY STREET, SUITE 106, SAN FRANCISCO, CA, 94107, US

(73) Assignee: Applied Materials, Inc.

(21) Appl. No.: 11/927,120

(22) Filed: Oct. 29, 2007

Related U.S. Application Data
(60) Provisional application No. 60/864,286, filed on Nov. 3, 2006.

(51) Int. Cl. B05C 13/00

(52) U.S. Cl. 118/500

(57) ABSTRACT

A support component comprises a support structure having a support surface with one or more quartz contact tips. In one version, the support component comprises a robot blade capable of transferring a substrate into and out of a chamber. The robot blade comprises a plate having a plurality of raised mesas, each raised mesa comprising a quartz contact tip which minimizes contact with the substrate thereby generating fewer contaminant particles during substrate transportation. Other versions of the support component include a heat exchange pedestal, lift pin assembly, and lifting fin assembly.

### CROSS-REFERENCE TO RELATED APPLICATION

This application claims priority to U.S. Provisional Application Ser. No. 60/864,286, filed Nov. 3, 2006, which is incorporated herein by reference and in its entirety.

### BACKGROUND

Embodiments of the present invention relate to substrate support components used to support or transport a substrate in a process chamber.

Electronic circuits of CPUs, displays and memories, are fabricated on a substrate in a process chamber by forming materials and layers on the substrate, and selectively etching the layers to form features. The substrates typically include semiconductor wafers and dielectrics. The substrate materials are deposited or formed by processes such as chemical vapor deposition (CVD), physical vapor deposition (PVD), oxidation, nitridation and ion implantation. The substrate materials are then etched to define electrical circuit lines, vias, and other features on the substrate. A typical process chamber has enclosure walls that enclose a substrate support, gas distributor and exhaust port, and can also include a gas energizer to energize process gas in the chamber by high frequency (RF) or microwave energy.

In a typical process cycle, the contact surfaces of different support components touch or contact the substrate. For example, a substrate is transported by a support component such as a transport blade operated by a robot arm from a substrate stack in a cassette in a load-lock chamber to a process chamber and vice versa. In the chamber, the blade places the substrate on a support component comprising a set of lift pins which are extended though holes in a substrate support, and then withdraws from the chamber. The lift pins retract into the substrate support to rest the substrate upon the receiving surface of the support. The substrate support can include a pedestal, a vacuum chuck having a vacuum port to suck down the substrate, or an electrostatic chuck comprising a dielectric covering an electrode to which a voltage is applied to generate an electrostatic force to hold the substrate.

The contact surfaces of the support components that contact the substrate often contaminate the substrate surface with contaminant particulates. For example, stainless steel surfaces of a pedestal leave behind trace amounts of iron, chromium or copper on the backside surfaces of the substrate. Nickel coated robotic blades can also contaminate the substrate with residual nickel particles. Similarly, aluminum robot blades can leave behind aluminum particulates on the substrate. Although the particulate contaminants are often deposited on the inactive backside surface of the substrate, they can diffuse to the active front side in high temperature processes causing failure of the circuits and displays formed on the substrate. The particulate contaminants can also flake off from the substrate and fall upon and contaminate other substrates to reduce the effective yields from the substrates.

Contaminant particles can also arise from the substrate itseIf due to abrasion of the backside or peripheral edge of the substrate when the substrate rubs against the support components, for example, during transportation of the substrate by robot blade or lifting up of the substrate by lift pins. Abrasion of the backside or edge of the substrate is particularly a problem when the support component has a surface which has a high hardness, for example, in diamond-like coating as taught in aforementioned U.S. patent application Ser. No. 10/786,876, entitled “Coating for Reducing Contamination of Substrates During Processing” to Parkhe et al., assigned to Applied Materials, Inc. and filed on Feb. 24, 2004, which is incorporated by reference herein in its entirety. The harder surface abrades the substrate to generate contaminant microparticles which remain on the support surface or stick to the substrate. However, if the component has a surface which is too soft, it is easily upgraded by the substrate which also creates contaminant particles that originate from the component material.

As the features formed on the substrates transition to smaller than 90 or even 45 nm, the defects caused by contaminant particles have an increasing effect in reducing substrate yields in the manufacturing process. Transitioning to smaller features sizes and geometries means smaller sized defects impact product yields, which in turn, have a larger effect on the overall cost structure of manufacturing the IC chips and displays.

Thus it is desirable to reduce contamination of the substrate by contaminant particles, increase substrate yields, and obtain better process efficiency. It is further desirable to have substrate support component that does not excessively abrade a substrate during its use. It is also desirable for the support surface to be resistant to abrasion by the substrate itself.

### DRAWINGS

The features, aspects, and advantages of the present invention will become better understood with regard to the following description, appended claims, and accompanying drawings, which illustrate examples of the invention. However, it is to be understood that each of the features can be used in the invention in general, not merely in the context of the particular drawings, and the invention includes any combination of these features, where:

FIG. 1 is a sectional top view of an embodiment of multi-chamber apparatus;

FIG. 2 is a sectional side view of an embodiment of a heat exchange chamber showing a heat exchange pedestal;

FIG. 3 is a perspective side view of an embodiment of a robot blade having raised mesas;

FIG. 4A is a top perspective view of the heat exchange pedestal shown in FIG. 2;

FIG. 4B is a detailed perspective view of the quartz piece in a hole in the heat exchange pedestal of FIG. 4A;

FIG. 4C is detailed perspective view of another embodiment of a removable assembly comprising a quartz piece in a hole in a heat exchange pedestal;

FIG. 5 is a sectional side view of an embodiment of a lift pin assembly having lift pins with quartz contact tips;

FIG. 6A is a perspective view of an embodiment of a lifting fin assembly having arcuate fins about a pedestal;

FIG. 6B is a top perspective view of an embodiment of an arcuate fin from the lifting assembly of FIG. 6A; and

FIG. 6C is a detailed perspective view of the raised protrusion having a quartz contact tip on a step-down ledge of an arcuate fin.

### DESCRIPTION

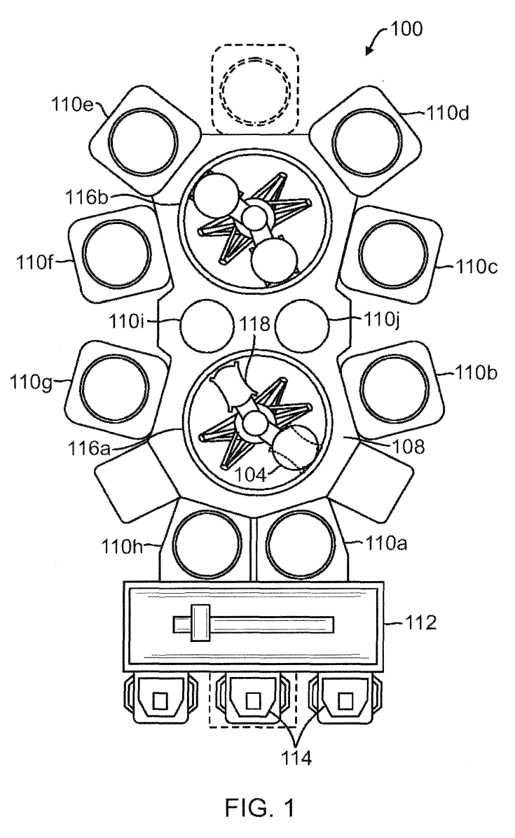

An embodiment of a substrate processing apparatus 100 suitable for processing substrates 104 is shown in FIG. 1. The apparatus 100 comprises a platform 108 such as an ENDURA™ type platform from Applied Materials, Inc., of Santa Clara, Calif., that provides electrical, plumbing, and other support functions. A plurality of processing chambers 110a-j are mounted on the platform 108. The chambers 110 can include, for example, a degassing chamber 110a to heat the substrate 104 before processing to degas a substrate 104; a pre-clean chamber 110b to clean a substrate 104; a processing chamber 110c to etch or deposit material on a substrate 104; and heat exchange chambers 110 h,j to heat or cool a substrate 104 after processing. The chambers 110a-j are interconnected to form a continuous vacuum environment within the apparatus 100 in which the process may proceed uninterrupted, thereby reducing contamination of substrates 104 that may otherwise occur when transferring the substrates 104 between separate chambers 110a-j for different process stages. The platform 108 also typically supports a load lock 112 which is used to receive one or more cassettes 114 of substrates 104 to be processed. A pair of substrate transfer chambers 116a,b contains robots 118 to transfer the substrates 104 from the cassettes to the different chambers 110a-j, and from one chamber 110 to another.

During processing, one substrate 104 at a time is transported or held by a support component 120 between or in the chambers 110a-j. The support components 120 includes transport and supporting components used to transfer a substrate 104 from a cassette 116 to a chamber 110a-d, from one chamber 110 to another chamber, lift and lower the substrate 104 in a chamber 110, and hold a substrate 104 during processing in a chamber. It should be understood that the exemplary embodiments of support components 120 that are described herein are provided to illustrate the present invention, and should not be used to limit the scope of the present invention, and that other versions of support components apparent to those of ordinary skill are also within the scope of the present invention.

The support components 120 have a quartz contact tip 124 that reduces the formation of contaminant particles from the substrate 104 or the component 120 itself to significantly improve the yields of integrated circuit chips and displays from the processed substrates 104. The quartz contact tip 124 forms at least a portion of the support surface 126 of the support structure 128 of the support component 120. The area of contact provided by the quartz contact tip 124 forms is smaller than the area of the support surface 126 to reduce contact and thus, contamination of the substrate 104.

It has been determined that the contaminant particles can be generated from the substrate 104 itself when the frictional and abrasive forces between the component 120 and the substrate 104 abrade the substrate or component. Such contamination is especially a problem when the component 120 is made from a material having a higher Mohr's hardness that the hardness of the material forming the backside of the substrate 104. Abrasive forces also create particles when the support surface is too soft because this surface itself is then abraded by the higher hardness of the backside of the substrate 104.

It is believed that the quartz contact tip 124 reduces contamination because it has the desired range of hardness values suitable supporting and transporting a substrate 104 made from a silicon or silicon oxide. The quartz contact tip 124 comprises a crystalline form of silicon dioxide which has a hexagonal crystal structure. The quartz contact tip 124 has a Mohr hardness of about 7 which has been determined to reduce abrasion of silicon wafers and glass panels. At the same time, the quartz contact tip 124 is sufficiently soft so as not to abrade the silicon wafer or display itself. The hardness of the quartz contact tip 124 can be measured by, for example, a hardness load and displacement indentation test. A suitable instrument for performing the hardness test can be a “Nano Indenter II” available from Nano Instruments, Inc. in Oak Ridge, Tenn. In this test, the tip of an indenter probe is placed against the quartz contact tip 124, and a load is applied to the indenter probe to press the tip into the surface 124 to form an indentation in the surface 124. The tip of the indenter probe can be, for example, pyramidal shaped, and a suitable load may be in the microgram range. The hardness of the surface 124 can be found by evaluating the indentation, for example, by taking a ratio of the force applied to the indenter probe divided by the area of the indentation that results from the force, as described for example in Review of Instrumented Indentation in the Journal of Research of the National Institute of Standards and Technology, Vol. 108, No. 4, July-August 2003, which is herein incorporated by reference in its entirety. The area of the indentation can be calculated, for example, optically or by monitoring a depth of the indenter probe in the surface 124 and using a known geometry of the tip of the indenter probe.

The quartz contact tip 124 also has a relatively low coefficient of friction which reduces the frictional forces between the substrate and coating which leads to lower abrasion of these surfaces. The quartz contact tip 124 can even have a coefficient of friction of less than about 0.3. The quartz contact tip 124 can also be polished to provide a coefficient of friction of less than about 0.2, and an average surface roughness of less than about 0.4 micrometers.

The quartz contact tip 124 can be fabricated in a crystalline solid form or deposited as coating to have a low level of metallic impurities such as Fe, Cr, Ni, Co, Ti, W, Zn, Cu, Mn, Al, Na, Ca, K and B. The metallic impurities rub off upon, and migrate from, the surfaces of the support components and into the substrates causing shorts in the substrate circuitry. Suitable quartz contact tip 124 have a metal concentration level of less than about 5×10¹² atoms/cm² of metal atoms at the surface 124 of the coating, or even less than about 5×10¹⁰ atoms/cm² of metal atoms.

Thus the quartz contact tip 124 of the support component 120 provides the desirable range of hardness, good frictional properties, and/or low-levels of contaminants. The quartz contact tip 124 covers at least a portion of the support surface 126 of a support structure 128 or may cover substantially the entire surface in contact with the substrate 104. The quartz contact tip 124 is also sufficiently thick to protect the substrate 104 from contamination by the underlying support structure 128, for example the quartz contact tip 124 may comprise a thickness of at least about 1 mm, such as from about 2 to about 6 mm or even from about 3.8 to about 4.1 mm. In one version, for example, the quartz contact tip 124 has a measured thickness of from about 3.835 mm to about 4.089 mm.

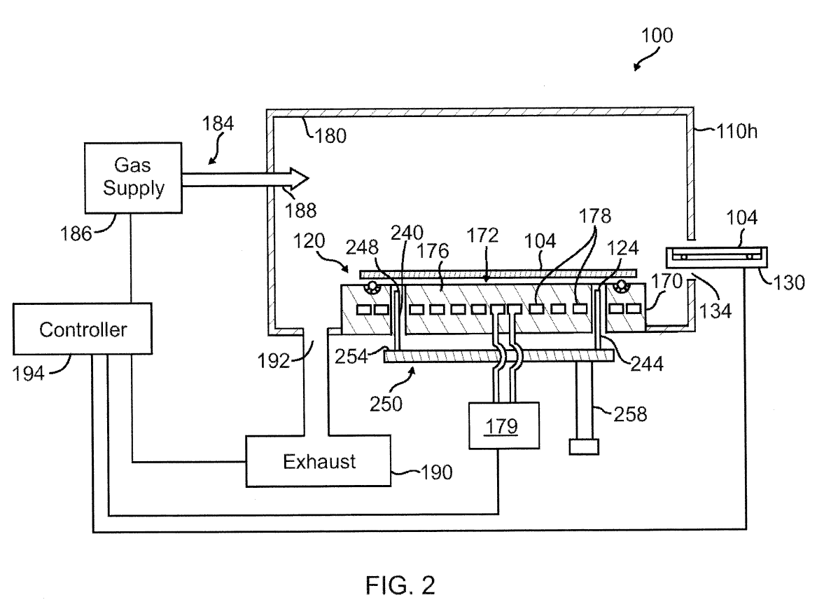

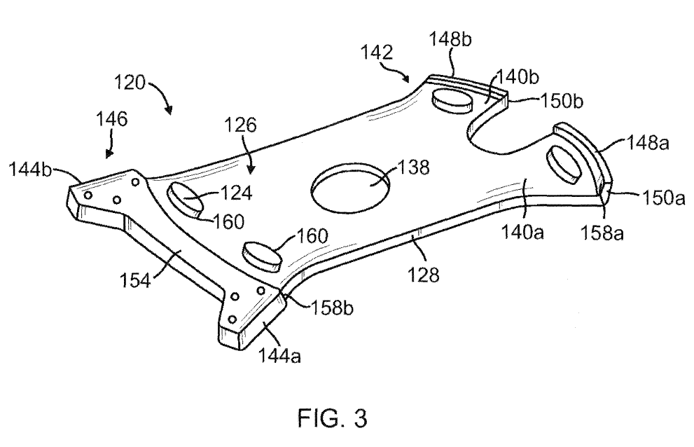

As one example, the substrate transfer chamber 116a on the platform contains a support component 120 comprising a robot 118 to transfer substrates 104 from the cassette 115 to the different chambers 110a-d for processing and return them after processing. In one embodiment, the robot 118 has a robot blade 130 capable of lifting and transferring a substrate 104 from the transfer chamber 116 and into and out of the chambers 110a-d through a slit 134 in the chamber as shown in FIG. 2. In one embodiment, the robot blade 130 comprises a plate 136 with a hole 138 in its center, as shown in FIG. 3. In one version, the plate 136 comprises a rectangular plate which has a pair of first angled prongs 140a,b extending from an inner end 142 and a pair of second angled prongs 144a,b extending from an outer end 146. The first angled prongs 140a,b of the inner end 142 each have an arcuate ridge 148a,b at their perimeters 150a,b, respectively. The pair of second angled prongs 144a,b extending from the outer end 146 have a continuous arcuate ledge 154 extending across both prongs 144a. The arcuate ledge 154 and arcuate ridges 148a,b having opposing arcuate inner edges 158a,b, respectively, which are shaped and sized to surround and more securely hold the peripheral edge of a circular substrate 104. The plate 136 is made from a ceramic, such as aluminum oxide, which is machined to the desired shape and size.

A plurality of raised mesas 160 extend out from the plate 136 of the robot blade 130. The mesas 160 are arranged on the support surface 126 of the support structure 128 of the support component 120 comprising the robot blade 130. The raised mesas 160 each have a quartz contact tip 124 that contacts the substrate 104 when the substrate is lifted by the blade 130. The quartz contact tips 124 present a much smaller area than the entire support surface 126 of the plate 136, and thus, minimize contact of the backside of a substrate 104 with the rest of the robot blade 130 resulting in less contamination of a substrate 104 during its transportation. The mesas 160 are also positioned within or inside the perimeter edge (not shown) of the backside of a substrate 104 that is confined by the opposing arcuate inner edges 158a,b of the arcuate ridges 148a,b and the arcuate ledge 154, respectively. The substrate 104 rests on the raised mesas 160 at its inner backside surface to minimize contact with the perimeter edge of the substrate 104 which typically has residual backside deposits. For example, the raised mesa 160 can be arranged to contact the backside of the substrate 104 within a substrate diameter that is at least about 4 mm inside the perimeter edge of the substrate 104 to reduce cross contamination of substrates 104 during their transfer in and out of a process chamber 110. The raised mesas 160 have a height of at least about 1 mm or even at least about 2 mm and are typically sized from about 3 to about 25 mm or even from about 8.6 to about 20 mm. Thus the quartz contact tip 124, which also have a thickness, have a height of from about 1.6 mm to about 2.4 mm above the surface of the plate 136. In one version the thickness of the quartz contact tip 124 is measured to be from about 1.930 mm to about 2.184 mm.

In another version, the support component 120 comprises a heat exchange pedestal 170, which is typically located in a heat exchange chamber 110h,j, an embodiment of which (110h), is shown in FIG. 3, to heat or cool a substrate 104 before or after processing in a process chamber 110. The heat exchange pedestal 170 heats or cools the substrate 104 to a desired temperature, such as a temperature suitable for handling the substrate after processing. The heat exchange pedestal 170 comprises a substrate receiving surface 172 on a body 176 which is a thermal conductor and shaped and sized to maximize heat exchange with a received substrate 104. In one version, the body 176 comprises a metal material, for example, stainless steel, aluminum and titanium. In one version, the body 176 of the heat exchange pedestal 170 comprises aluminum.

The body 176 of the pedestal 170 comprises one or more conduits 178 provided for the passage of a heat exchanging fluid from a fluid source 179 through the body 176. The conduits 170 can be spiral tube that spirals inward, a doubled over tube that traverses across the pedestal 170, or other conventional configurations. In one version, the heat exchanging chamber 110h is a cooling chamber, and in use, a cooled fluid is passed through the conduits 178 of the heat exchange pedestal 170 to cool the substrate 104. The heat exchange pedestal 170 when operated as a cooling pedestal is capable of cooling the substrate 104 to a temperature of less than about 80° C. The heat exchange pedestal 170 can also be a heating pedestal having the same structure but with a heating fluid, i.e, a fluid heated to a temperature passed through the conduit 178 to heat the overlying substrate 104.

The heat exchange chamber 110h comprises an enclosure wall 180. During cooling, a cooling or heating gas can also be passed into the chamber 110 through a gas distributor 184 that includes a gas supply 186 and at least one gas inlet 188 feeding the chamber 110h. An exhaust 190 includes an exhaust port 192 that receives the cooling gas from the chamber and pumps out the same with an exhaust pump (not shown). A controller 194 comprising computing hardware and software can be used to control the chamber components, including the heat exchange pedestal 170 and the temperature and flow rate of the fluid passed through the conduits 178 of the pedestal 170, as well as the gas introduced into the chamber thorough the gas inlet 188.

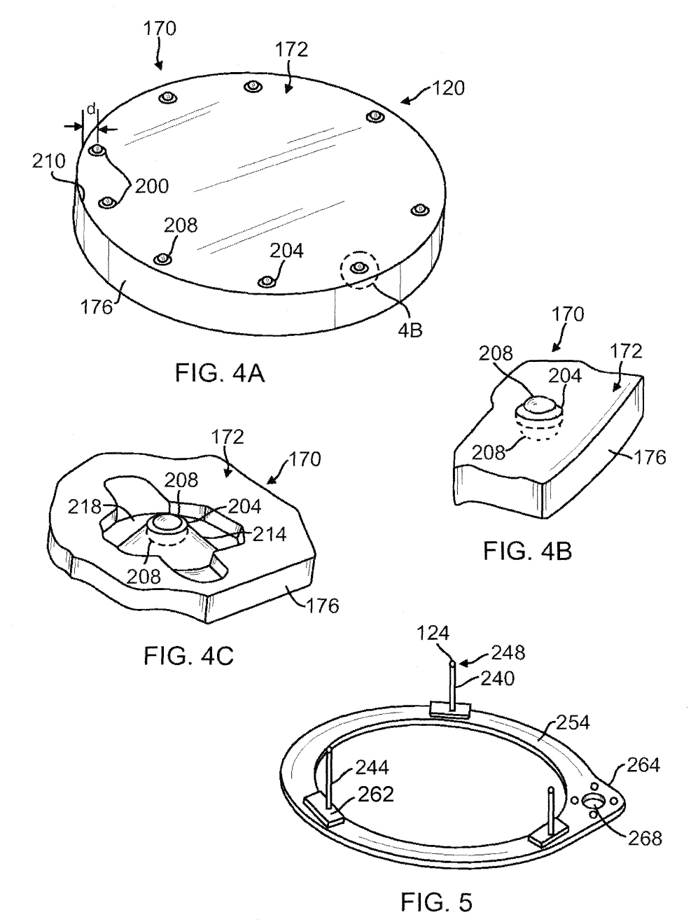

The heat exchange pedestal 170 further comprises a plurality of holes 200 arranged about the receiving surface 172 of the body 176, as shown in FIG. 4A. Each hole 200 contains a rubber ring 204 sized to hold in place a quartz piece 208 having the quartz contact tip 124 thereon, as shown in FIG. 4B. The quartz contact tip 124 of the quartz pieces 208 contacts the backside of the substrate 104 to lift the substrate off from the receiving surface of the body 176 of the pedestal 170. The height of the quartz pieces 208 above the receiving surface 172 is selected to inhibit contamination and abrasion of the substrate 104 with entire area of the receiving surface 172 of the body 176 of the pedestal 170 while holding the substrate sufficiently close to the pedestal surface to allow heating or cooling by heat transfer to or from the substrate 104. For example, a suitable height of the quartz pieces 208 above the receiving surface 172 is from about 0.25 to about 6 micrometers. The quartz pieces 208 can be shaped in the form of spherical balls (as shown), or can have other shapes, such as oblate spheroids, ovals, etc., as would be apparent to one of ordinary skill in the art.

In one version, the holes 200 and quartz pieces 208 therein, are arranged a distance d away from a perimeter 210 of the receiving surface 172 of the body 176. The distance d is selected to be a sufficiently large distance to avoid contact of the backside perimeter edge of the substrate 104 which typically has residual backside deposits thereon, with the quartz contact tip 124 of the quartz pieces 208. For example, the quartz pieces 208 and holes 200 can be arranged to contact the backside of the substrate 104 within a substrate diameter that is at least about 4 mm from the perimeter edge of the substrate 104. This avoids contamination of the quartz contact tips 24 with the residual backside contaminants of the substrate 104.

Another embodiment of a removable assembly 212 comprising a quartz piece 208 in a hole 200 in a heat exchange pedestal 170 is shown in FIG. 4C. In this version, the quartz piece 208 is mounted in a hole 204 that is within a raised cone 214. The raised cone 214 is mounted on a flat and thin disc 218 which can be removed from a recess 220 in the pedestal 170. As such, the removable assembly 212 with the quartz piece 208 can be more easily removed and replaced as needed, for example when the quartz piece 208 wears away with friction against the substrate 104. The recess 220 can be shaped, as shown, with two U-shaped cut-outs 224 extending from an octagonal center orifice 226.

The support components 120 further comprise lift pins 240 which are extended out of the pedestal 170 to receive a substrate 104 transported into the chamber 110h by the robot blade 130, as shown in FIG. 2. While the lift pins 170 are described as extending out of the heat exchange pedestal 170, they may also extend out of other substrate support structures, such as other pedestals or even an electrostatic chuck. The lift pins 240 are then retracted into the pedestal 170 and the substrate 104 is held on the pedestal 170. The lift pins 240 comprise a moveable elongated member 244 having a tip 248 adapted to lift and lower a substrate from a surface of a pedestal 170. In one version, the elongated member 244 are composed of a ceramic, such as for example, aluminum oxide. The embedded members 244 each comprise a quartz contact tip 124 that covers at least a portion of the tip 248 of the lift pin to contact and thereby reduce contamination of the substrate 104. In one version, the quartz contact tip 124 has a thickness or from about 1 micrometer to about 4 micrometers.

The lift pins 160 are part of a lift pin assembly 250 which includes a lift pin support 254 that holds the lift pins 240 and that is attached to a movable post 258 to raise and lower the lift pins 240 as shown in FIG. 2. The lift pin support 254 is typically as circular hoop 260 onto which the lift pins 240 are mounted within rectangular tiles 262. The circular hoop 260 comprises a wedge 264 comprising an orifice 268 for mounting on the movable post 258 which lifts and lowers the lift pin support 254. The circular hoop 260 is typically made from a metal, such as aluminum.

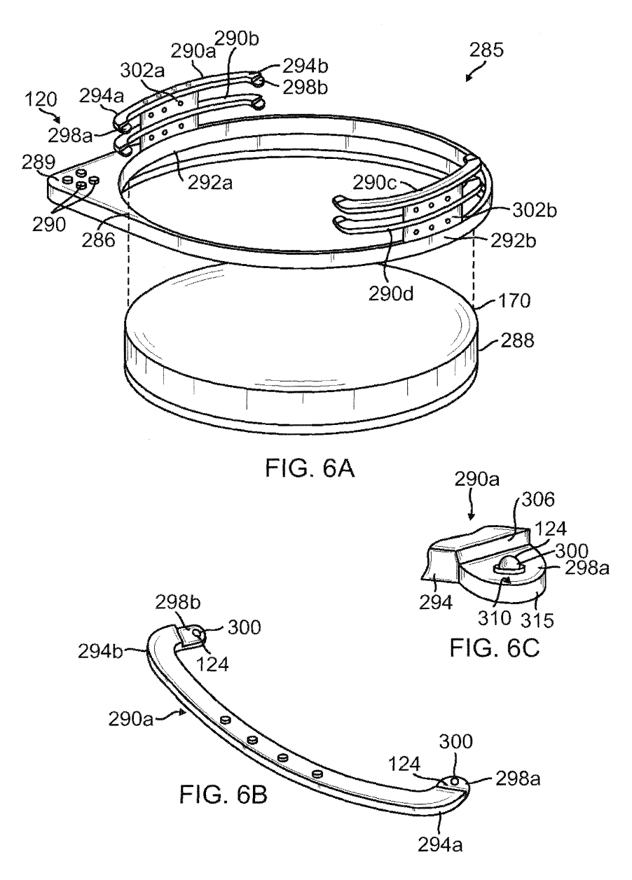

In yet another version, the support component 120 comprises a substrate lifting fin assembly 285, an exemplary version of which is shown in FIGS. 6A-6C. The lifting fin assembly 285 is adapted to lift a substrate 104 from a support structure and transport the substrate 104, for example, the substrate lifting fin assembly 285 may be adapted to lift and lower a substrate 104 onto and off the heat exchange pedestal 170. The lifting assembly 285 comprises a circular hoop 286 that is sized to fit about a periphery 288 of the pedestal 170. The circular hoop 286 comprises a wedge 289 comprising a plurality of bolts 290 for mounting on a movable member (not shown) which lifts and lowers the hoop 286. The circular hoop 260 is typically made from a metal, such as aluminum.

A first pair of arcuate fins 290a,b are mounted at one portion 292a of the circular hoop 286, and a second pair of arcuate fins 290c,d are mounted at another portion 292b of the hoop 286 which is in an opposing or facing arrangement. The arcuate fins are mounted on the flat walls 302a,b which in turn are mounted on the circular hoop 286. Each of the arcuate fins 290 comprises two ends 294a,b that each have a step-down ledge 298a,b that extends radially inward toward the pedestal 170. The second pair of arcuate fins 290c,d are mounted below the first pair of arcuate fins 290a,b to allow the simultaneous transport of more than one substrate 104. In one version, the arcuate fins 290a-d are composed of a metal, such as for example stainless steel or aluminum.

The step-down ledges 298 on each opposing end 294a,b of the arcuate fins 290 cooperate to form a lifting structure capable of lifting a substrate 104 off, and onto, the pedestal 170 by setting the substrate 104 on the ledges 190. The step-down ledges 298a,b may be connected to the opposing ends 294a,b by a beveled connecting region 306 that slopes downwardly from each end 294a,b to the step-down ledge 298a. The step-down ledges 298a,b are desirably sized to suitably support the substrate 104, and may also extend inwardly a sufficient distance to support the substrate 104 without excessive contact or rubbing between the beveled connecting region 306 and the substrate 104, thereby reducing the contamination of the substrate 104. For example, to lift and transport a substrate 104 having a diameter of about 300 mm, the ledges 298a,b may extend inwardly from the opposing ends 294a,b by at least about 7 mm.

Each step-down ledges 298a comprises a raised protrusion 300 having a quartz contact tip 124, as shown in FIG. 6C. The raised protrusions 300 are on the upper surface 310 of each step-down ledge 298a. A substrate 104 lifted by the arcuate fins 290 contacts substantially only the quartz contact tip 124 of the raised protrusions 300 to minimize contact between the substrate 104 and arcuate fins 290 during lifting and lowering of the substrate 104. Minimizing contact between the substrate 104 and ledge 298a further reduces the contamination of the substrate 104 by the ledge 298a providing better yields in the processing of a substrate 104. Also, substrates 104 that have already been contaminated can be safely handled by the lifting fin assembly 285 without transferring contamination to the substrates.

The raised protrusion 300 are also located inward from the perimeter 315 of the ledge 298a, such that the quartz contact tip 124 of the raised protrusion 300 contacts the substrate 104 at regions away from the perimeter edge of the backside of the substrate 104, which are typically less contaminated than the perimeter edge portion. For example, the raised protrusion 300 may be spaced away from the perimeter such that they contact the substrate at a diameter that is at least about 4 mm inside the perimeter of the substrate 104, and even at least about 7 mm inside the perimeter. A suitable height of the raised protrusions 300 to minimize contact of the substrate 104 with the surface 310 of the step-down ledge 298 can be a height of at least about 1 mm, such as from about 1 mm to about 2 mm, and even at least about 1.5 mm.

Although exemplary embodiments of the present invention are shown and described, those of ordinary skill in the art may devise other embodiments which incorporate the present invention, and which are also within the scope of the present invention. For example, the robot blade 130, heat exchange pedestal 170, lift pins 240, or other support components 120 may comprise other shapes and configurations other than those described herein. Furthermore, relative or positional terms shown with respect to the exemplary embodiments are interchangeable. Therefore, the appended claims should not be limited to the descriptions of the preferred versions, materials, or spatial arrangements described herein to illustrate the invention.

What is claimed is:

1. A robot blade capable of transferring a substrate into and out of a chamber, the robot blade comprising:
(a) a plate; and
(b) a plurality of raised mesas on the plate, each raised mesa comprising a quartz contact tip,
whereby the substrate contacts substantially only the quartz contact tips of the raised mesas to minimize contact of the substrate with the robot blade and thereby generate fewer contaminant particles.

2. A robot blade according to claim 1 wherein the plate comprises a rectangular plate.

3. A robot blade according to claim 2 wherein the rectangular plate comprises inner and outer ends, and wherein a pair of first angled prongs extend from the inner end and a pair of second angled prongs extend from the outer end.

4. A robot blade according to claim 3 wherein the first angled prongs each comprise a perimeter with an arcuate ridge, and the second angled prongs comprise a continuous arcuate ledge, and wherein the arcuate ledge and arcuate ridges having opposing arcuate inner edges shaped and sized to surround a circular substrate.

5. A robot blade according to claim 1 wherein the plate comprises a ceramic.

6. A robot blade according to claim 4 wherein the mesas are also positioned within a perimeter edge of the backside of a substrate that is confined by the opposing arcuate inner edges of the arcuate ridges and arcuate ledge.

7. A robot blade according to claim 1 wherein the raised mesas have a height of at least about 1 mm.

8. A robot blade according to claim 1 wherein the quartz contact tip has a height of from about 1.6 to about 2.4 mm above the surface of the plate.

9. A heat exchange pedestal for receiving a substrate in a chamber, the heat exchange pedestal comprising:
(a) body that is shaped and sized to maximize heat exchange with the received substrate, the body comprising one or more conduits provided for the passage of a heat exchanging fluid therethrough;
(b) a substrate receiving surface on the body, the substrate receiving surface comprising a plurality of holes; and
(c) a plurality of quartz pieces, each quartz piece positioned in a hole of the substrate receiving surface, and having a quartz contact tip to contact the backside of the substrate received on the pedestal.

10. A pedestal according to claim 9 wherein each hole contains a rubber ring sized to hold a quartz piece.

11. A pedestal according to claim 9 wherein the height of the quartz pieces above the substrate receiving surface is from about 0.25 to about 6 micrometers.

12. A pedestal according to claim 9 wherein the quartz pieces comprise spherical balls or oblate spheroids.

13. A pedestal according to claim 9 wherein the substrate receiving surface of the body comprises a perimeter, and wherein the holes are arranged a distance d away from the perimeter that is sufficiently large to avoid contact between a perimeter edge of the backside of the substrate with the quartz contact tips of the quartz pieces.

14. A pedestal according to claim 13 wherein the holes are arranged to contact the backside of the substrate within a substrate diameter that is at least about 4 mm from the perimeter edge of the substrate.

15. A pedestal according to claim 9 wherein the holes are each within a raised cone.

16. A pedestal according to claim 15 wherein the raised cone is mounted on a flat disc.

17. A pedestal according to claim 16 wherein the pedestal comprises a recess comprising two U-shaped cut-outs extending from an octagonal center orifice, and wherein the flat disc can be folded and inserted into the recess in the pedestal.

18. A lift pin assembly to lift and lower a substrate on to a pedestal, the lift pin assembly comprising:
(a) a lift pin support;
(b) a plurality of lift pins mounted on the lift pin support, the lift pins comprising an elongated member having a tip adapted to lift and lower a substrate from the pedestal, and the lift pins each comprising a quartz contact tip that covers at least a portion of the tip of the lift pin to contact and thereby reduce contamination of a substrate.

19. A lift pin assembly according to claim 18 wherein the quartz contact tip 124 has a thickness or from about 1 micrometer to about 4 micrometers.

20. A lift pin assembly according to claim 18 wherein the elongated member comprises a ceramic.

21. A lift pin assembly according to claim 18 wherein the ceramic comprises aluminum oxide.

22. A lift pin assembly according to claim 18 wherein the lift pin support comprises a circular hoop having rectangular tiles onto which the lift pins are mounted.

23. A lift pin assembly according to claim 22 wherein the circular hoop comprises a wedge comprising an orifice for mounting on a movable post to lift and lower the lift pin support.

24. A lift pin assembly according to claim 22 wherein the circular hoop is made from a metal.

25. A lifting fin assembly to lift a substrate from a substrate support and transport the substrate, the lifting fin assembly comprising:
(a) a circular hoop sized to fit about a periphery of a pedestal; and
(b) a first pair of arcuate fins mounted on the circular hoop, each arcuate fin comprises two opposing ends that each have a step-down ledge that extends radially inward and has a raised protrusion with a quartz contact tip, whereby a substrate lifted by the arcuate fins contacts substantially only the quartz contact tip of the raised protrusions to minimize contact between the substrate and arcuate fins.

26. A lifting fin assembly according to claim 25 wherein the step-down ledges extend inwardly from the opposing ends by at least about 4 mm.

27. A lifting fin assembly according to claim 25 wherein the raised protrusions are spaced inwardly by at least about 4 mm from the perimeter of the step-down ledge.

28. A lifting fin assembly according to claim 25 wherein the raised protrusions comprise a height above a surface of the step-down ledge that is at least about 1 mm.

29. A lifting fin assembly according to claim 25 further comprising a second pair of arcuate fins mounted below the first pair of arcuate fins.

30. A lifting fin assembly according to claim 25 wherein the arcuate fins are composed of stainless steel or aluminum.
